(19) United States
(12) Patent Application Publication
(10) Pub. No.: US 2023/0281332 A1
(43) Pub. Date: Sep. 7, 2023

(54) ACCESS CONTROL METHOD, ACCESS CONTROL PROGRAM, AND INFORMATION PROCESSING APPARATUS

(71) Applicant: Fujitsu Limited, Kawasaki-shi (JP)

(72) Inventor: Chihiro KATO, Kawasaki (JP)

(73) Assignee: Fujitsu Limited, Kawasaki-shi (JP)

(21) Appl. No.: 18/087,451

(22) Filed: Dec. 22, 2022

(30) Foreign Application Priority Data
Mar. 1, 2022 (JP) 2022-031310

(51) Int. Cl. G06F 21/62

(52) U.S. Cl. CPC G06F 21/6218

(57) ABSTRACT

An access control method is performed by a computer. The method includes: when detecting generation of a process in any of one or more containers, registering an association relationship between the generated process and an address for network communication in the container having the generated process in management information; when detecting an output of an access request to a database, identifying a transmission source process using a transmission source port number of the access request from among one or more processes associated with a transmission source address of the access request in the management information; identifying transmission source software executed by the identified transmission source process; and determining whether access to the database according to the access request from the identified transmission source software is permitted.

### CROSS-REFERENCE TO RELATED APPLICATION

This application is based upon and claims the benefit of priority of the prior Japanese Patent Application No. 2022-31310, filed on Mar. 1, 2022, the entire contents of which are incorporated herein by reference.

### FIELD

Embodiments discussed herein are related to an access control method, an access control program, and an information processing apparatus.

### BACKGROUND

In an operation environment for executing various pieces of software such as application software, it is very important to appropriately restrict access from each piece of software to data in a database (DB). For example, in a case where confidential information provided by a third party is handled, there is a risk that a leakage of the confidential information by mistake may lead to a serious problem. Therefore, it is desired not only to inhibit such leakage by regulations and rules, but also to enable an access control mechanism within a computer system to perform access restriction.

Software to be subjected to access control may be executed in a virtual execution environment called a container in some cases. A container for executing software is managed by using management software called an orchestration tool. In the orchestration tool, software for controlling a network mechanism inside a cluster is often used together. An example of software for controlling a network mechanism is a mechanism called a sidecar proxy. A representative example is open source software (OSS) called Envoy.

The sidecar proxy is capable of performing control such as restriction of access from software to a DB by using a port number of the software. For example, when each piece of software accesses a DB via a network, a port number for communication is allocated to the piece of software. In a case of a piece of software whose port number is fixedly determined, DB access control for the piece of software may be performed based on the port number of an access request.

In a relational database management system (RDBMS) which is software for data management, there is also a mechanism for data access control. The RDBMS sets an access right for each user, and determines whether or not to permit access to data according to the right. This right may be set at many granularities such as per table, per row, and per column.

As a technique for managing containers, for example, there has been proposed a monitoring system capable of detecting an unauthorized operation by using a monitoring result of communication performed between containers.

Japanese Laid-open Patent Publication No. 2020-115358 is disclosed as related art.

### SUMMARY

According to an aspect of the embodiments, an access control method causing a computer to execute a process including: when detecting generation of a process in any of one or more containers, registering an association relationship between the generated process and an address for network communication in the container having the generated process in management information; when detecting an output of an access request to a database, identifying a transmission source process using a transmission source port number of the access request from among one or more processes associated with a transmission source address of the access request in the management information; identifying transmission source software executed by the identified transmission source process; and determining whether or not access to the database according to the access request from the identified transmission source software is permitted.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example of an access control method according to a first embodiment;

FIG. 2 is a diagram illustrating an example of a system configuration according to a second embodiment;

FIG. 3 is a diagram illustrating an example of hardware of a node;

FIG. 4 is a diagram illustrating an example of per-application DB access management;

FIG. 5 is a diagram illustrating a first example of DB access control in the related art;

FIG. 6 is a diagram illustrating a second example of DB access control in the related art;

FIG. 7 is a diagram illustrating an example of application identification via an inode number;

FIG. 8 is a diagram illustrating a third example of DB access control in the related art;

FIG. 9 is a block diagram illustrating an example of a per-application access control function;

FIG. 10 is a diagram illustrating an example of life and death monitoring processing;

FIG. 11 is a diagram illustrating an example of container detailed information;

FIG. 12 is a diagram illustrating an example of a Pod information resource group;

FIG. 13 is a flowchart illustrating an example of a processing procedure in response to Pod generation;

FIG. 14 is a diagram illustrating an example of a Pod information resource to which a PID of a generated process is added;

FIG. 15 is a flowchart illustrating an example of a processing procedure in response to process generation;

FIG. 16 is a diagram illustrating flows of information in DB access;

FIG. 17 is a flowchart illustrating an example of an application file path acquisition procedure;

FIG. 18 is a diagram illustrating an example of a method of acquiring a coupling target table name;

FIG. 19 is a diagram illustrating an example of permission information acquired from a custom resource;

FIG. 20 is a sequence diagram illustrating an example of speculative DB access processing; and

FIG. 21 is a sequence diagram illustrating an example of speculative DB access processing in a case where it takes time to execute a query.

### DESCRIPTION OF EMBODIMENTS

In software executed on containers, there are many pieces of software each of which transmits data by performing communication using a port number not used at that time. In a case where a piece of software whose port number varies every time communication is performed accesses a DB via a network, it is not possible to efficiently determine which type of software is associated with the port number of an access request in the related art. For this reason, efficient restriction for accessing DB per type of software is difficult.

According to one aspect, an object of the present disclosure is to enable efficient access restriction per type of software.

Hereinafter, embodiments will be described with reference to the drawings. Two or more of the embodiments may be implemented in combination within a range without contradiction.

### First Embodiment

A first embodiment is an access control method capable of performing DB access restriction per type of software.

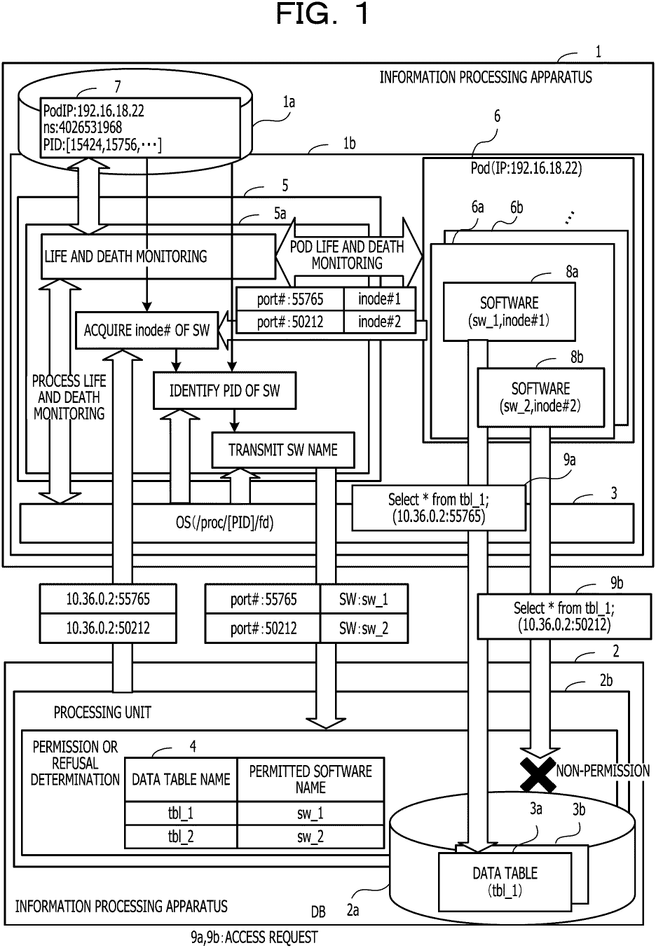

FIG. 1 is a diagram illustrating an example of an access control method according to the first embodiment. FIG. 1 illustrates an example in which the access control method is performed by information processing apparatuses 1 and 2. The information processing apparatuses 1 and 2 are, for example, computers and are enabled to implement the access control method by executing an access control program.

The information processing apparatus 1 includes a storage unit 1a and a processing unit 1b. The storage unit 1a is a memory or a storage device included in the information processing apparatus 1. The processing unit 1b is, for example, a processor or an arithmetic circuit included in the information processing apparatus 1. The information processing apparatus 2 includes a database (DB) 2a and a processing unit 2b. The DB 2a is a memory or a storage device included in the information processing apparatus 2. The processing unit 2b is, for example, a processor or an arithmetic circuit included in the information processing apparatus 2.

The storage unit 1a of the information processing apparatus 1 stores management information 7 specifying an association relationship between one or more processes in one or more containers 6a, 6b, and ... in a Pod 6 and an address for network communication of the Pod 6 (Pod IP: 192.16.18.22). The address for network communication is, for example, an Internet Protocol (IP) address. Each process is specified by, for example, a process ID of the process (PID: [15424, 15756, ...]). The management information 7 includes, for example, information specifying a network namespace (ns: 4026531968) used in the Pod 6. The information specifying a network namespace is, for example, an inode number of a file associated with the network namespace.

The processing unit 1b of the information processing apparatus 1 includes Pods 5 and 6 each of which is a set of containers serving as virtual execution environments for software. The Pod 5 includes a container 5a, and the Pod 6 includes containers 6a, 6b, and ..., for example. The container 5a is a container for monitoring the other Pod 6 and the containers 6a, 6b, and ... in the Pod 6. The containers 6a, 6b, and ... are containers for executing pieces of software 8a and 8b for use to provide services in response to requests from users. An address for network communication is allocated to each of the Pods 5 and 6. The containers in each of the Pods 5 and 6 share the address allocated to the Pod to which the containers belong.

In the container 6a, for example, processes for executing the respective pieces of software 8a and 8b are generated. Each of the processes outputs an access request 9a or 9b to the DB 2a when processing using data in the DB 2a is generated during execution of the corresponding piece of software 8a or 8b. A transmission source address of the output access requests 9a and 9b is the address allocated to the Pod 6. A transmission source port number of the access request 9a or 9b is a port number not used by any other process at a time point of output of the access request 9a or 9b. For this reason, it is impossible to know in advance which port number will be used by the access request 9a or 9b from each piece of software 8a or 8b.

The container 5a in the Pod 5 is used for life and death monitoring of the Pod 6 and life and death monitoring of the processes in the Pod 6. For example, the life and death monitoring of the Pod 6 may be performed by using an application programming interface (API) prepared for managing the Pods 5 and 6. The API for managing the Pods 5 and 6 is provided by an API server (not illustrated), for example. For example, every time a Pod for containers using the same address for network communication is generated, a monitoring process in the container 5a generates the management information 7 to be associated with the generated Pod.

The life and death monitoring of the processes may be performed via an operating system (OS) 3 of the information processing apparatus 1. For example, the monitoring process in the container 5a may perform the life and death monitoring of the processes in the container 6a by monitoring whether a file for each process managed by a file system of the OS 3 is generated or not.

When detecting that a process is generated in any of the one or more containers 6a, 6b, and ..., the monitoring process in the container 5a registers identification information of the generated process in the management information 7 in association with the address of the Pod 6. For example, the monitoring process acquires, via the OS 3, the inode number of a file associated with the network namespace used by the generated process. The monitoring process registers the identification information of the generated process in a piece of the management information 7 including the acquired inode number.

The monitoring process in the container 5a detects that the transmission source processes executing the pieces of software 8a and 8b (transmission source software) in the Pod 6 output the access requests 9a and 9b to the DB 2a. For example, the monitoring process in the container 5a is capable of detecting the output of each of the access requests 9a and 9b by receiving a set of the transmission source address and the transmission source port number of the access request 9a or 9b output from the information processing apparatus 2.

When detecting the output of each of the access requests 9a and 9b to the DB 2a, the monitoring process in the container 5a identifies one or more processes associated with the transmission source address of the detected access request 9a or 9b in the management information 7. The monitoring process in the container 5a identifies the transmission source process using the transmission source port number of the access request 9a or 9b from among the identified one or more processes. For example, the monitoring process in the container 5a acquires file identification information of a file (for example, a buffer of received data) used in communication using the transmission source port number, and acquires identification information of the transmission source process based on the acquired file identification information. The identification information of the file is, for example, an inode number.

For example, the monitoring process in the container 5a transmits, to the information processing apparatus 2, information specifying the pieces of software 8a and 8b being executed by the transmission source processes that output the access requests 9a and 9b. The information specifying each piece of software is, for example, the name of the software (software name). For example, the monitoring process in the container 5a uses the identification information of each of the processes that output the access requests 9a and 9b to acquire, from the OS 3, a file name of an execution file being executed by the process and a path specifying a storage location of the file. The monitoring process in the container 5a transmits a set of the path and the file name as a software name to the information processing apparatus 2. Hereinafter, a set of a path and a file name will be referred to as a file path in some cases.

In the example illustrated in FIG. 1, according to the set of the transmission source address and the transmission source port number “10.36.0.2:55765”, the monitoring process in the container 5a transmits a software name “sw_1” of the software associated with the port number “55765” to the information processing apparatus 2. According to the set of the transmission source address and the transmission source port number “10.36.0.2:50212”, the monitoring process in the container 5a transmits a software name “sw_2” of the software associated with the port number “50212” to the information processing apparatus 2.

When receiving the access request 9a or 9b to the DB 2a from the information processing apparatus 1, the processing unit 2b of the information processing apparatus 2 transmits the set of the transmission source address and the transmission source port number of the access request 9a or 9b while designating the address of the Pod 5 of the information processing apparatus 1. The information specifying the piece of software 8a or 8b executed by the process that transmits the access request 9a or 9b is transmitted from the information processing apparatus 1. Based on the piece of software 8a or 8b executed by the process that transmits the access request 9a or 9b, the processing unit 2b determines whether or not the access to the DB 2a is permitted.

For example, the DB 2a includes multiple data tables 3a and 3b. In each of the access requests 9a and 9b, a data table to be accessed is designated. The processing unit 2b has permission information 4, for each data table, specifying software permitted to access the data table. For example, in the permission information 4, a software name whose access to a data table is permitted (permitted software name) is set in association with a data table name of the data table. The processing unit 2b determines whether or not access is permitted based on the permission information 4.

When the access according to the access request 9a or 9b is permitted, the processing unit 2b accesses the DB 2a according to the access request 9a or 9b, and transmits an access result to the information processing apparatus 1. When the access according to the access request 9a or 9b is not permitted, the processing unit 2b transmits an error message to the information processing apparatus 1 without accessing the DB 2a according to the access request 9a or 9b.

In the example illustrated in FIG. 1, the access target of the access request 9a output from the process executing the piece of software 8a is the data table 3a having a data table name “tbl_1”. In the permission information 4, the access to the data table 3a from the software name “sw_1” is permitted. Accordingly, when the processing unit 2b recognizes that the software name of the transmission source software of the access request 9a is “sw_1”, the processing unit 2b executes the access to the data table 3a according to the access request 9a.

The access target of the access request 9b output from the process executing the piece of software 8b is also the data table 3a having the data table name “tbl_1”. In the permission information 4, the access to the data table 3a from the software name “sw_2” is not permitted. Accordingly, when the processing unit 2b recognizes that the software name of the transmission source software of the access request 9b is “sw_2”, the processing unit 2b refuses the access to the data table 3a according to the access request 9b.

The processing unit 2b is capable of recognizing a piece of software using a temporarily allocated port number by acquiring the software name associated with the port number from the container 5a implemented in the same information processing apparatus 1 as that of the containers 6a, 6b, and ... as described above. This consequently enables data table access restriction per type of software by using the port number. The information processing apparatus 1 performs the life and death monitoring of the processes in the containers 6a, 6b, and ..., and thereby manages the association relationship between the Pod 6 and the processes in the management information 7 in advance. For this reason, for each of the access requests 9a and 9b using the address of the Pod 6 as the transmission source address, the transmission source process that outputs the access request 9a or 9b may be searched out from among the processes generated in the Pod 6. Therefore, in a case where a large number of Pods exist in addition to the Pod 6 in the information processing apparatus 1, it is possible to efficiently identify the transmission source process that outputs each of the access requests 9a and 9b.

In registering the association relationship between the address of the Pod 6 and the generated processes in the management information 7, the information of the network namespace of the Pod 6 may be advantageously used. For example, the monitoring process in the container 5a sets the information specifying the network namespace used in common by the containers 6a, 6b, and ... in the Pod 6 in association with the address used in common by the containers 6a, 6b, and ... in the management information 7. The monitoring process in the container 5a registers identification information of each generated process in association with the address associated with the network namespace used by the generated process in the management information 7.

Since the information specifying the network namespace of the Pod 6 is contained in the management information 7, it is easy to acquire the file identification information associated with the transmission source port number. For example, the Pod 5 and the Pod 6 often use different network namespaces. Accordingly, in order for a process in the Pod 5 to acquire information managed in the network namespace in the Pod 6, the process in the Pod 5 performs processing of identifying the network namespace in the Pod 6. For example, when the information specifying the network namespace is set in advance in the management information 7, the monitoring process in the container 5a is enabled to access the network namespace in the Pod 6 and acquire the file identification information of the file used in the communication using the transmission source port number. This makes it easy to identify the network namespace of the Pod 6 and acquire the file identification information associated with the transmission source port number.

Based on the acquired file identification information, the monitoring process in the container 5a acquires the identification information of the process that outputs each of the access requests 9a and 9b. At this time, the monitoring process in the container 5a searches for a file associated with the acquired file identification information from among the files respectively used by the processes registered in association with the Pod 6 in the management information 7, for example. Since the search target is limited to the files respectively used by the processes registered in association with the Pod 6 in the management information 7 as described above, the efficient processing is possible.

Although the two information processing apparatuses 1 and 2 are described as apparatuses which perform the access control in the example illustrated in FIG. 1, an entire system including the two information processing apparatuses 1 and 2 may be referred to as one information processing apparatus. The DB 2a may be provided in the information processing apparatus 1. In this case, the processing such as the permission or refusal determination, which is executed by the processing unit 2b of the information processing apparatus 2, is executed by the information processing apparatus 1, and the access control is achieved by only the single information processing apparatus 1.

### Second Embodiment

Next, a second embodiment will be described. A system according to the second embodiment speculatively executes DB access management per piece of application software (hereafter referred to as an application) and thereby reduces a delay in the access to the DB due to the access management.

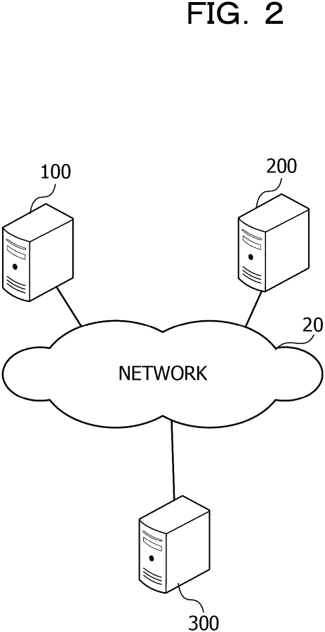

FIG. 2 is a diagram illustrating an example of a system configuration according to the second embodiment. In the second embodiment, three nodes 100, 200, and 300 are coupled to each other via a network 20. The node 100 manages access from an application to a DB by using a container. The node 200 executes the application by using a container. The node 300 manages the containers executed in the nodes 100 and 200.

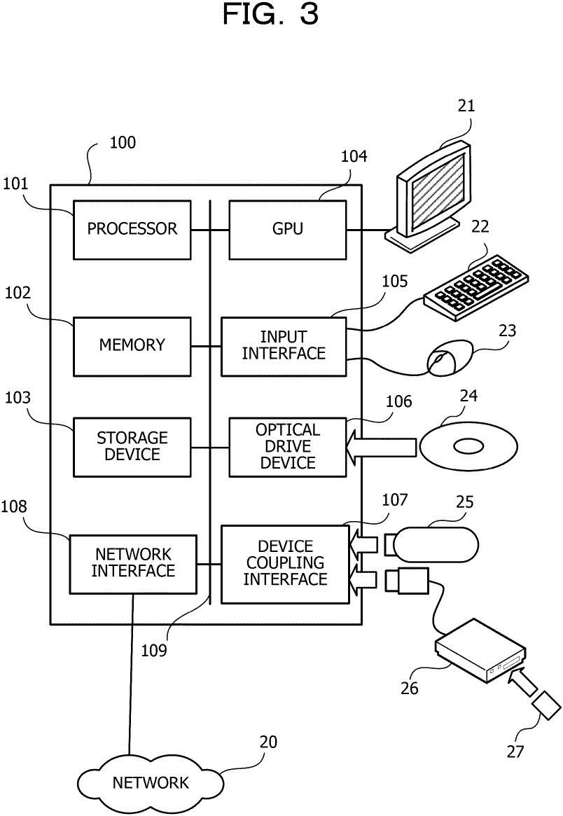

FIG. 3 is a diagram illustrating an example of hardware of a node. An entire system of the node 100 is controlled by a processor 101. A memory 102 and multiple peripheral devices are coupled to the processor 101 via a bus 109. The processor 101 may be a multiprocessor. The processor 101 is, for example, a central processing unit (CPU), a microprocessor unit (MPU), or a digital signal processor (DSP). At least part of functions implemented by the processor 101 executing a program may be implemented by an electronic circuit such as an application-specific integrated circuit (ASIC) or a programmable logic device (PLD).

The memory 102 is used as a main storage device of the node 100. The memory 102 temporarily stores at least part of an OS program and application programs which are to be executed by the processor 101. The memory 102 stores various types of data to be used for processing by the processor 101. As the memory 102, for example, a volatile semiconductor storage device such as a random-access memory (RAM) is used.

The peripheral devices coupled to the bus 109 include a storage device 103, a graphics processing unit (GPU) 104, an input interface 105, an optical drive device 106, a device coupling interface 107, and a network interface 108.

The storage device 103 writes and reads data electrically or magnetically to a built-in recording medium. The storage device 103 is used as an auxiliary storage device of the computer. The storage device 103 stores the OS program, the application programs, and various types of data. As the storage device 103, for example, a hard disk drive (HDD) or a solid-state drive (SSD) may be used.

The GPU 104 is an arithmetic device that performs image processing, and is also referred to as a graphic controller. A monitor 21 is coupled to the GPU 104. The GPU 104 displays images on a screen of the monitor 21 in accordance with an instruction from the processor 101. As the monitor 21, a display device using organic electro luminescence (EL), a liquid crystal display device, or the like is used.

A keyboard 22 and a mouse 23 are coupled to the input interface 105. The input interface 105 transmits to the processor 101 signals transmitted from the keyboard 22 and the mouse 23. The mouse 23 is an example of a pointing device, and other pointing devices may be used. Examples of the other pointing devices include a touch panel, a tablet, a touch pad, a track ball, and the like.

The optical drive device 106 reads data recorded in an optical disk 24 or writes data to the optical disk 24 by using laser light or the like. The optical disk 24 is a portable recording medium in which data is recorded in a manner readable through reflection of light. Examples of the optical disk 24 include a Digital Versatile Disc (DVD), a DVD-RAM, a compact disc read-only memory (CD-ROM), a CD-recordable (CD-R), a CD-rewritable (CD-RW), and the like.

The device coupling interface 107 is a communication interface for coupling peripheral devices to the node 100. For example, a memory device 25 and a memory reader/writer 26 may be coupled to the device coupling interface 107. The memory device 25 is a recording medium equipped with a function of communication with the device coupling interface 107. The memory reader/writer 26 is a device that writes data to a memory card 27 or reads data from the memory card 27. The memory card 27 is a card-type recording medium.

The network interface 108 is coupled to the network 20. The network interface 108 transmits and receives data to and from another computer or communication device via the network 20. The network interface 108 is, for example, a wired communication interface that is coupled to a wired communication device such as a switch or a router by a cable. Instead, the network interface 108 may be a wireless communication interface that is coupled to a wireless communication device such as a base station or an access point for communication through radio waves.

The node 100 is capable of implementing processing functions of the second embodiment by using the hardware as described above. The nodes 200 and 300 may be also implemented by the same hardware as that of the node 100 illustrated in FIG. 3. The information processing apparatuses 1 and 2 described in the first embodiment may also be implemented by the same hardware as that of the node 100 illustrated in FIG. 3.

For example, the node 100 implements the processing functions of the second embodiment by executing a program recorded in a computer-readable recording medium. The program in which details of processing to be executed by the node 100 are written may be recorded in any of various recording media. For example, the program to be executed by the node 100 may be stored in the storage device 103. The processor 101 loads at least part of the program in the storage device 103 to the memory 102, and executes the program. The program to be executed by the node 100 may be recorded in a portable recording medium such as the optical disk 24, the memory device 25, or the memory card 27. The program stored in the portable recording medium is made executable after the program is installed in the storage device 103 under the control of the processor 101, for example. The processor 101 may read the program directly from the portable-type recording medium and execute the program.

The other nodes 200 and 300 are also enabled to implement the processing functions of the second embodiment by executing the program recorded in the computer-readable recording medium as in the case of the node 100.

Description will be given of per-application DB access management to be achieved according to the second embodiment.

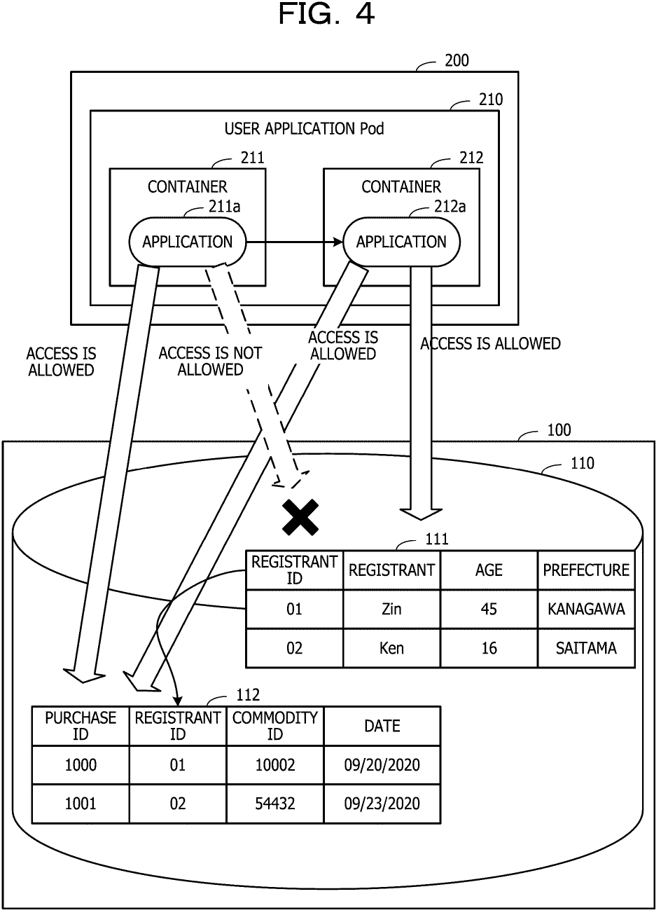

FIG. 4 is a diagram illustrating an example of per-application DB access management. The node 100 has a DB 110. The DB 110 holds therein confidential information containing personal information (address and name) by using an RDBMS. In the RDBMS, data is divided into multiple data tables and stored. Each data table stores data that matches data definitions determined for the data table. In the RDBMS, there are one or more data tables, and some of the data tables have a dependency relationship in some cases.

In the example illustrated in FIG. 4, a registrant information table 111 and a purchase information table 112 are present in the DB 110. The registrant information table 111 includes registrant ID, registrant, age, and prefecture columns and registers multiple records containing data relevant to the columns. The purchase information table 112 includes purchase ID, registrant ID, commodity ID, and date columns, and registers multiple records containing data relevant to the columns. The registrant information table 111 and the purchase information table 112 are associated with each other via the registrant ID.

The node 200 accesses the DB 110 by using containers 211 and 212. It is assumed that the containers 211 and 212 are managed by a container orchestration tool. The container orchestration tool manages containers on a per-Pod basis. The containers 211 and 212 are included in a user application Pod 210.

As in the containers 211 and 212 in the user application Pod 210, containers in the same Pod have a shared storage access environment and a shared network access environment, and use the same network namespace. For this reason, the containers are enabled to easily communicate with each other. In many cases, a container that includes a program for performing a main operation and several containers that execute helper programs for supporting the main operation (such as log collection, proxy, controller, and backup) are used as a Pod. Such containers that execute the helper programs are referred to as sidecar containers.

The node 200 has the user application Pod 210. The user application Pod 210 is an execution unit for executing an application. The user application Pod 210 includes multiple containers 211 and 212. An application 211a is executed in the container 211. An application 212a is executed in the container 212.

For example, it is assumed that the application 212a is an application that anonymizes data read from the DB 110. Since the registrant information table 111 includes the personal information of users, it is appropriate to use the data read from the registrant information table 111 after the data is anonymized by processing. For this reason, the node 100 performs access control such that only the application 212a is allowed to access the registrant information table 111. In this case, the application 211a is allowed to access the data in the registrant information table 111 via the application 212a. Since the purchase information table 112 does not include personal information, the node 100 performs control such that both the applications 211a and 212a are allowed to access the purchase information table 112.

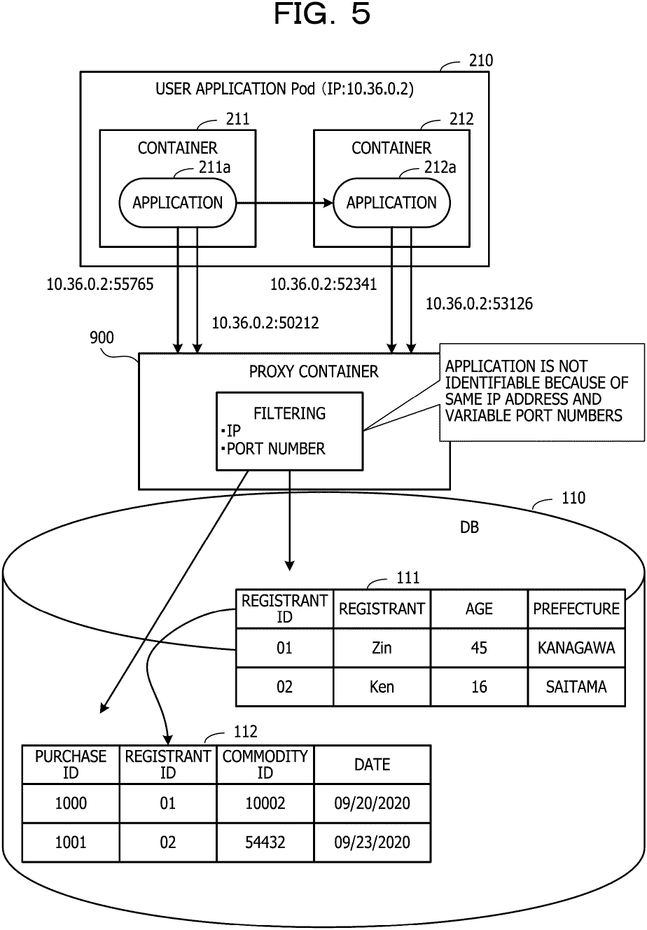

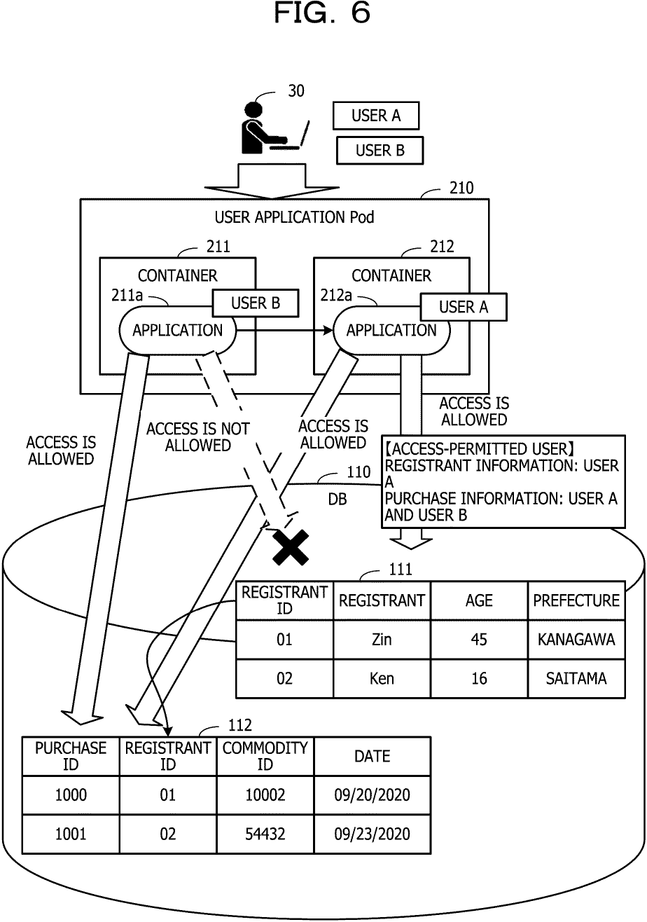

As described above, the node 100 performs access control on a per-table basis to impose access restriction that varies among applications. Hereinafter, with reference to FIGS. 5 and 6, description will be given of difficulty in performing access control to impose access restriction that varies among applications.

FIG. 5 is a diagram illustrating a first example of DB access control in the related art. FIG. 5 illustrates an example in which a container orchestration tool using a sidecar container controls access to the DB 110. A proxy container 900 is inserted as a sidecar container. Thus, communication via the proxy container 900 may be filtered and statistical information thereof may be stored. For example, the proxy container 900 is able to perform filtering based on the IP address and the port number of a transmission source of an access request to the DB 110. The proxy container 900 is able to acquire the IP address and the port number of the transmission source from a header of a packet used to transmit the access request. However, it is assumed that the proxy container 900 illustrated in FIG. 5 does not have a function of acquiring identification information (such as an application name) of the application 211a or 212a associated with the port number.

In a case where the containers 211 and 212 are managed on a per-Pod basis, an IP address is allocated on the per-Pod basis. For this reason, in a case where filtering is performed using the proxy container 900 based on the IP address and the port number of the transmission source, the applications 211a and 212a in the same user application Pod 210 are indistinguishable based on the IP address alone. A transmission source port number is individually allocated to each transmission source. In this allocation, a free port number is used unless specifically set by the transmission source. For example, the port numbers respectively used by the applications 211a and 212a are dynamically changed, and therefore the proxy container 900 has no way to identify a type of application of the transmission source of an access request based on the port number of the access request.

The proxy container 900 also has no way to know an access target data table only from the IP address and the port number. For this reason, in order for the proxy container 900 to make application-dependent determination as to whether or not access to each of the tables in the DB 110 is permitted, an ability to identify a type of application associated with the IP address and the port number of a transmission source is insufficient.

FIG. 6 is a diagram illustrating a second example of DB access control in the related art. FIG. 6 illustrates an example in which per-application access control is enabled by using a per-user access control function in the RDBMS.

For each table, the RDBMS has a mechanism of limiting a user who is permitted to access the table. Accordingly, a Pod creator 30 executes the applications 211a and 212a with different user accounts. For example, the application 211a is executed with a user account of “user B”, and the application 212a is executed with a user account of “user A”.

In the RDBMS, “user A” is set as a user who is allowed to access the data (registrant information) set in the registrant information table 111. “User A and user B” are set as users who are allowed to access the data (purchase information) set in the purchase information table 112. In this way, a per-user access right is definable for each table in the RDBMS. The RDBMS permits access to data if the access is from an application executed with a user account allowed to access.

In the example illustrated in FIG. 6, the application 211a executed with the account of the “user B” is allowed to access the purchase information table 112 but is not allowed to access the registrant information table 111. Meanwhile, the application 212a executed with the account of the “user A” is allowed to access both the registrant information table 111 and the purchase information table 112. The use of the management of access rights of each user account in the RDBMS as described above makes it possible to perform per-application access control by associating each application with relevant user accounts.

However, the RDBMS is able to determine the user account of an application of an access request source, but has no way to know which application is executed with this user account. For this reason, in a case where the Pod creator 30 sets an incorrect relationship between an application and a user account in the RDBMS, there is a possibility that access to a table from an application whose access is to be refused may be permitted.

In a case where an individual user account is allocated to each of the multiple applications 211a and 212a, the single Pod creator 30 has to manage multiple user accounts for executing the respective applications 211a and 212a. As the number of applications increases, associations between the applications and user accounts are likely to be set erroneously. To limit user accounts for use to execute the applications to the accounts of the Pod creator 30 is not a measure usable for general purpose because the flexibility of operations of the system is reduced.

As described above, the restriction by the proxy using the IP address and the port number has a problem that it is not possible to make the per-application determination as to whether or not access to each table is permitted. Meanwhile, in the access control for each table, the access control in the RDBMS by associating users with applications is inappropriate because this complicates operations and management of the system.

Under these circumstances, the system described in the second embodiment achieves per-application access control without imposing an excessive burden on the Pod creator 30. Although the DB 110 is managed in the RDBMS in the second embodiment, the structure of the DB 110 is not limited to the RDBMS. For example, the per-application access control described in the second embodiment may be applied to DBs under access control of types such as a document DB called NoSQL and a graph DB.

The namespace (network namespace) of the IP address and the port number of the user application Pod 210 in the node 200 is the same as the namespace of the OS of the node 200 in some cases. In this case, an application of a transmission source of a query for accessing the DB 110 may be uniquely identified by inquiring of the OS of the node 200 the application associated with the IP address and the port number of the transmission source of the query. However, since sharing of a network namespace increases a security risk, this setting is not allowed in some cases.

For example, a conceivable solution is to enable a file path of an application associated with a port number to be acquired via an information acquisition container by using an inode number. The inode number is an identification number of an inode specifying information on each of files or directories (also referred to as folders) in a file system. The inodes are provided in association with all files or directories. For this reason, an inode number is usable as identification information of each file or directory. For example, the inode number of a file storing an application program uniquely specifies this application program.

The inode numbers are in common regardless of the network namespaces. Accordingly, when information is traced via an inode number from a set of an IP address and a port number of a transmission source of a query output from an application in a Pod, the application may be identified. Information specifying an application is, for example, a set (file path) of the name of the application (application name) and a path to a storage location of an execution file of the application.

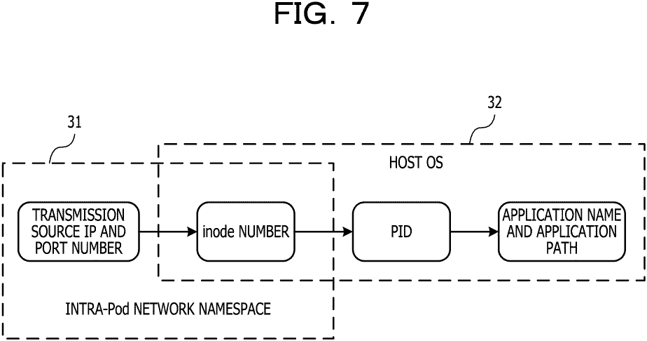

FIG. 7 is a diagram illustrating an example of application identification via an inode number. For example, a query output from an application running in a certain Pod contains a set of the IP address and the port number of the transmission source managed in an intra-Pod network namespace 31 (transmission source IP and port number). In the intra-Pod network namespace 31, based on the set of the IP address and the port number of a transmission source, the associated inode number may be identified.

A host OS 32 manages, as information on a process that executes an application program, the inode number of a file of the application program being executed by the process. Thus, based on the inode number of the application that outputs the query, the host OS 32 is able to identify the process ID (PID) of the process that is executing the application. Based on the PID, the host OS 32 is able to identify the name and the path of the application being executed by the process.

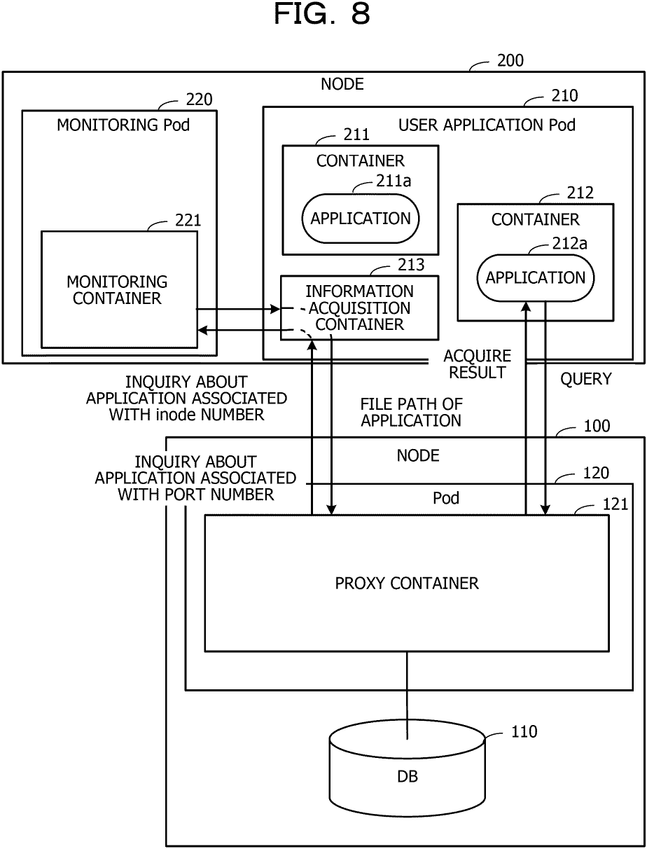

FIG. 8 is a diagram illustrating a third example of DB access control in the related art. In the example illustrated in FIG. 8, the user application Pod 210 of the node 200 is provided with an information acquisition container 213 in addition to the containers 211 and 212. The node 200 is provided with a monitoring Pod 220. The monitoring Pod 220 includes a monitoring container 221 for monitoring operations of the applications 211a and 212a in the node 200. The node 100 includes the DB 110 and a Pod 120. The Pod 120 includes a proxy container 121.

When acquiring a query from the application 212a, the proxy container 121 acquires the IP address and the port number from a packet including the query. The proxy container 121 transmits an inquiry about an application associated with the port number of the transmission source of the query to the information acquisition container 213 in the user application Pod 210 having the acquired IP address. It is assumed that a port number for packet reception of the information acquisition container 213 is fixedly determined and is registered in the proxy container 121 in advance.

Based on the port number designated in the inquiry about the application, the information acquisition container 213 acquires the inode number associated with the port number. Regarding the port number, there is a file (for example, a buffer of received data) used for communication using the port number, and an inode number is given to the file. The inode number is unique in the node 200 regardless of namespaces.

The information acquisition container 213 inquires of the monitoring container 221 an application associated with the inode number. The monitoring container 221 searches a /proc directory for the designated inode number, and acquires an association relationship between the inode number and the file path of the application. The monitoring container 221 transmits the acquired file path of the application to the information acquisition container 213. The information acquisition container 213 transmits the received file path of the application to the proxy container 121.

Based on the file name included in the file path of the application, the proxy container 121 recognizes that the transmission source of the query is the application 212a. If the access from the application 212a to an access target table of the query is permitted, the proxy container 121 executes the query and transmits the execution result to the application 212a.

As described above, even when a network namespace is not shared between the Pod and the OS in the node 200, the proxy container 121 is able to acquire the file path of the application associated with the port number by using the inode number. The proxy container 121 is able to identify the application based on the file path and determine whether or not the access to the DB 110 is permitted.

However, the technique illustrated in FIG. 8 still has some problems. A first problem is that components are distributed to form a complicated mechanism. For example, the proxy container 121 inquires of the monitoring container 221 via the information acquisition container 213 in the user application Pod 210. Accordingly, the number of communications between the Pods increases, and when the communications between the Pods fail somewhere, access to the DB 110 is stopped. For this reason, it is desirable to simplify the mechanism and reduce the number of communications.

A second problem is that the processing speed is low. In the mechanism illustrated in FIG. 8, when identifying a process using an inode number, for example, the monitoring container 221 performs all scanning on folders under “/proc/[PID]/fd” of all processes to find the PID using the corresponding inode number. In this case, as the number of processes in the node 200 increases, the time until the finding increases. For example, in a case where there are about 1600 processes, it takes about 0.25 seconds for the all scanning. Because this time is proportional to the number of processes, the overhead is large in a situation where a system in business operation actively executes many processes. Also for increasing the practicality, it is desirable to reduce the processing time for the proxy container 121 to determine whether or not access to the DB 110 is permitted for each query.

To address this, the monitoring container 221 collects information useful for identifying an application associated with a set of an IP address and a port number in advance. This enables the proxy container 121 to recognize an application of a transmission source of a query only by inquiring of the monitoring container 221 with designation of the set of the IP address and the port number of the transmission source of the query.

For example, the monitoring container 221 performs life and death monitoring of Pods and life and death monitoring of processes. In the life and death monitoring of Pods, information (such as an IP address) of a newly generated Pod may be obtained. In the life and death monitoring of processes, a generated process may be classified into one of Pods to which the process belongs.

The monitoring container 221 performs the life and death monitoring of Pods and the life and death monitoring of processes to collect useful information in advance, so that the efficiency of processing in response to issuance of a query may be improved.

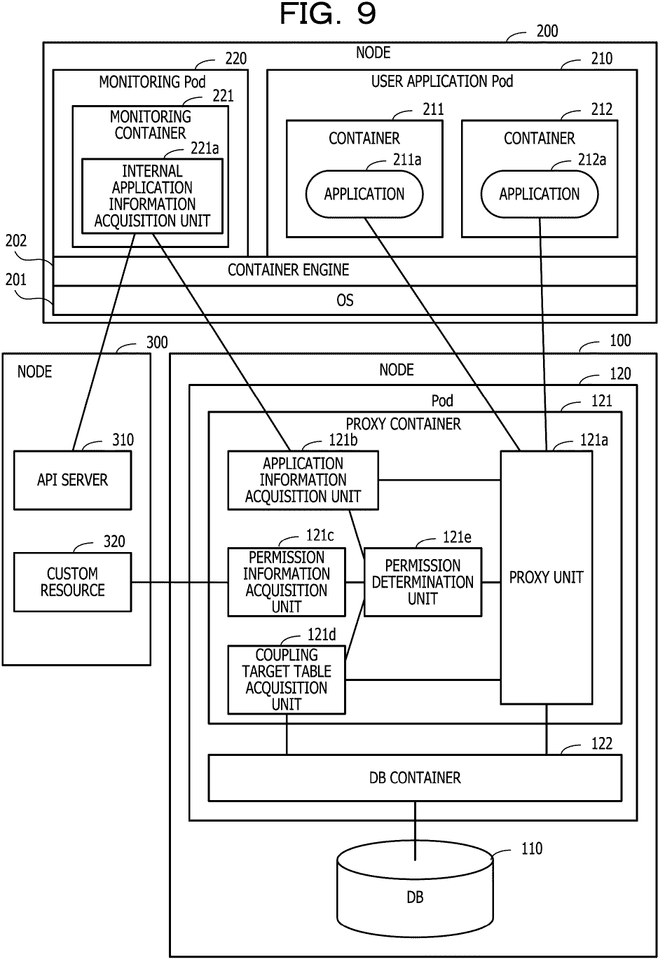

FIG. 9 is a block diagram illustrating an example of a per-application access control function. The node 100 includes the DB 110 and the Pod 120. The DB 110 is managed with a RDBMS. The DB 110 and the Pod 120 are functions implemented by the processor 101 of the node 100 executing a program.

The Pod 120 includes the proxy container 121 and a DB container 122. The proxy container 121 performs access control by catching inter-container communication in the middle of the communication, and determining whether or not the communication is permitted based on an application of a transmission source and content (query) of the communication. The DB container 122 manages the data in the DB 110 with the RDBMS.

The proxy container 121 includes a proxy unit 121a, an application information acquisition unit 121b, a permission information acquisition unit 121c, a coupling target table acquisition unit 121d, and a permission determination unit 121e.

The proxy unit 121a acquires a query that is an access request to the DB 110 from any of the applications 211a and 212a. The proxy unit 121a transfers the acquired query to the DB container 122, and if the access is to an accessible table, transmits an access result to the application of the transmission source of the query.

The application information acquisition unit 121b inquires of the monitoring container 221 information on the application associated with the port number of the transmission source of the query. The application information acquisition unit 121b transmits the acquired information on the application to the permission determination unit 121e. Here, the application information acquisition unit 121b recognizes location information of the monitoring container 221 in advance. For example, the application information acquisition unit 121b may acquire the location information of the monitoring container 221 from an API server 310 in a node 300.

The permission information acquisition unit 121c acquires, from a custom resource 320 in the node 300, permission information specifying an association relationship between an application and a table in the DB 110 which the application is to be permitted to access. The permission information acquisition unit 121c transmits the acquired permission information to the permission determination unit 121e.

The coupling target table acquisition unit 121d acquires the name of an access target data table according to the query (coupling target table name) from the DB container 122. The coupling target table acquisition unit 121d transmits the acquired coupling target table name to the permission determination unit 121e.

The permission determination unit 121e determines whether or not to permit access according to the query based on the information of the application associated with the port number of the transmission source of the query, the permission information, and the coupling target table name. The permission determination unit 121e transmits a determination result to the proxy unit 121a.

In the node 200, a container engine 202 is executed on an OS 201, and the user application Pod 210 and the monitoring Pod 220 are generated by the container engine 202. The OS 201, the container engine 202, the user application Pod 210, and the monitoring Pod 220 are functions implemented by a processor of the node 200 executing a program. In the node 100, the Pod 120 is also generated by a container engine executed on the OS, although not illustrated in FIG. 9.

The monitoring Pod 220 includes the monitoring container 221. The monitoring container 221 includes an internal application information acquisition unit 221a.

The internal application information acquisition unit 221a communicates with the API server 310 to perform the life and death monitoring of the user application Pod 210. The internal application information acquisition unit 221a acquires information on the user application Pod 210 by performing the life and death monitoring of the user application Pod 210, and stores, as a Pod information resource, the association relationship between the network namespace and the user application Pod 210. For example, the user application Pod 210 is specified by an IP address.

The internal application information acquisition unit 221a communicates with the OS 201 to perform the life and death monitoring of the processes executing the applications 211a and 212a. The internal application information acquisition unit 221a identifies in which Pod each generated process is running by performing the life and death monitoring of the processes, and stores the association relationship between the network namespace and the process in the Pod information resource.

When receiving the set of the IP address and the port number of a transmission source of a query, the internal application information acquisition unit 221a acquires the file path of the application of the transmission source of the query by using the Pod information resource.

The node 300 includes the API server 310 and the custom resource 320. The API server 310 and the custom resource 320 are functions implemented by a processor of the node 300 executing a program.

The API server 310 is an API provided by a container orchestration tool, and manages information on activation and stop of a Pod in a node, a location of each container (node that executes the container), and the like. The custom resource 320 is an extension API of the container orchestration tool, and is a given function prepared by a Pod creator. For example, the custom resource 320 has permission information specifying an association relationship between a data table and an application permitted to access the data table. In response to an acquisition request for the permission information, the custom resource 320 transmits the permission information to the proxy container 121.

Lines coupling the elements illustrated in FIG. 9 represent some of communication paths, and other communication paths other than the illustrated communication paths may also be set.

Every time any of the applications 211a and 212a outputs a query for access to the DB 110, the system having the configuration illustrated in FIG. 9 is able to efficiently perform permission or refusal determination processing on the access according to the query. For efficient permission or refusal determination, the monitoring container 221 performs the life and death monitoring of Pods and the life and death monitoring of processes and generates Pod information resources.

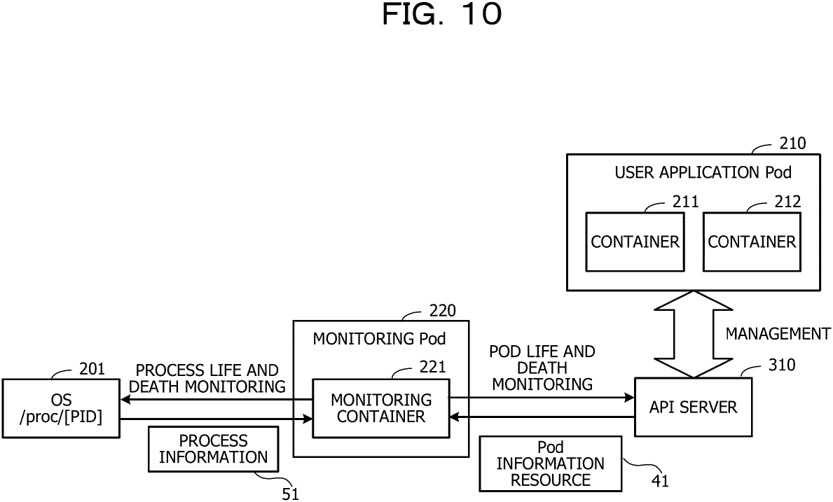

FIG. 10 is a diagram illustrating an example of life and death monitoring processing. The monitoring container 221 included in the monitoring Pod 220 performs the life and death monitoring of the user application Pod 210 via, for example, the API server 310. For example, when a certain resource is created, updated, or deleted, the API server 310 is able to detect it. By using the function of the API server 310, the monitoring container 221 performs the life and death monitoring of the user application Pod 210.

For example, the monitoring container 221 periodically acquires, from the API server 310, information on Pods to be managed by the API server 310. When detecting generation of the user application Pod 210, the monitoring container 221 acquires a Pod information resource 41 about the user application Pod 210 from the API server 310. For example, the Pod information resource 41 includes the IP address of the user application Pod 210, the inode number for the network namespace of the user application Pod 210, and the PID of each container in the user application Pod 210.

The monitoring container 221 performs the life and death monitoring of the processes in the user application Pod 210 via, for example, the OS 201. The OS 201 has management files of processes generated in the node 200. For example, the monitoring container 221 may perform the life and death monitoring of a process by detecting generation or deletion of a file (/proc/[PID]) for managing the process. When a process is generated, the monitoring container 221 acquires process information 51 from the management file of the process. For example, the process information 51 includes the PID, information specifying the network namespace (the inode number of the network namespace), and the like.

Based on the inode number of the network namespace specified in the process information 51, the monitoring container 221 identifies the user application Pod 210 including the concerned process. The monitoring container 221 registers the PID of the generated process in the Pod information resource 41 of the identified user application Pod 210.

Next, regarding the life and death monitoring processing, processing in response to Pod generation will be described in detail. When detecting generation of the user application Pod 210, the internal application information acquisition unit 221a in the monitoring container 221 performs processing of identifying a common network namespace in the user application Pod 210. Detailed information acquired from the user application Pod 210 does not include information directly specifying the network namespace in the user application Pod 210. For this reason, the internal application information acquisition unit 221a traces container detailed information from the ID of a container in the user application Pod 210 and identifies the process of the container. From information on the identified process, the internal application information acquisition unit 221a acquires information (inode number) specifying the network namespace in the user application Pod 210.

For example, when the container engine 202 is Docker (registered trademark), the internal application information acquisition unit 221a may acquire the PID of the container by acquiring the container detailed information based on the container ID. A docker inspect command may be used to acquire the container detailed information.

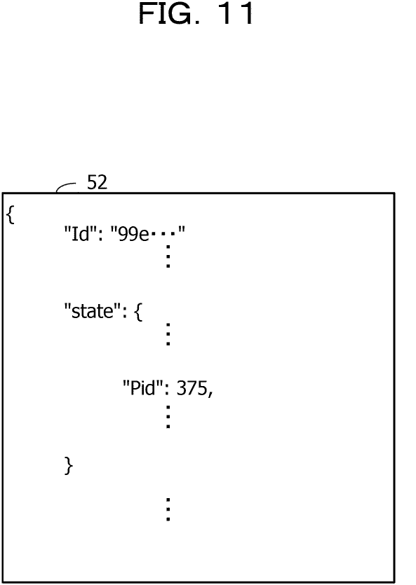

FIG. 11 is a diagram illustrating an example of container detailed information. For example, container detailed information 52 contains the ID of a container and additionally the PID of a process in the container. In the example illustrated in FIG. 11, a PID “375” is specified in the container detailed information 52.

The network namespace is shared in the user application Pod 210. For this reason, when the PID of the container in the user application Pod 210 is known, it is possible to access the common network namespace in the user application Pod 210. Thus, the internal application information acquisition unit 221a accesses the network namespace used by the process associated with the PID specified in the container detailed information 52. The internal application information acquisition unit 221a acquires, from the OS 201 for example, the inode number of a file “/proc/[PID]/ns/net” for detecting a process that shares the network namespace.

The internal application information acquisition unit 221a saves the generated information on the user application Pod 210 as a Pod information resource. Also when another user application Pod is generated, the internal application information acquisition unit 221a generates and stores a Pod information resource in the same manner. As a result, a Pod information resource group is generated. The Pod information resource group is an example of the management information 7 in the first embodiment.

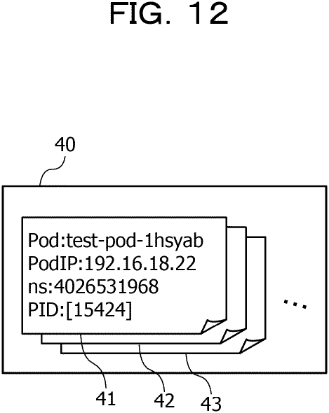

FIG. 12 is a diagram illustrating an example of a Pod information resource group. A Pod information resource group 40 includes multiple Pod information resources 41, 42, 43, ... For example, the Pod information resource 41 includes a Pod name “test-pod-1hsyab”, an IP address “192.16.18.22”, an inode number “4026531968”, and a PID “15424” of a process in the user application Pod 210. The inode number specified in the Pod information resource 41 is an inode number of a file specifying information on the network namespace.

The PID included in the Pod information resource 41 is the PID of one container in the user application Pod 210, and is not necessarily the same as the PID of the application 211a or 212a running in the user application Pod 210. For example, in a case where the application 211a is internally activated after the container 211 is activated, a process different from that of the container 211 is generated for executing the application 211a. When a query is transmitted from the application 211a, the PID of the transmission source of the query is the PID of the process that executes the application 211a. For this reason, it is not possible to identify the transmission source application associated with the PID of the transmission source only from the information illustrated in FIG. 12.

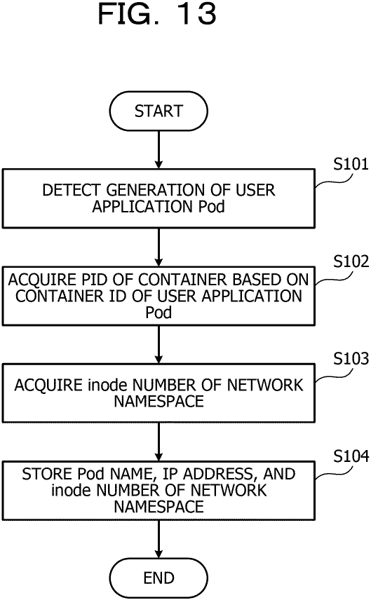

FIG. 13 is a flowchart illustrating an example of a processing procedure in response to Pod generation. Hereinafter, the processing illustrated in FIG. 13 will be described in the order of step numbers.

[STEP S101] The internal application information acquisition unit 221a detects generation of a user application Pod. For example, the internal application information acquisition unit 221a acquires information on user application Pods to be managed from the API server 310, and when there is an unknown user application Pod, detects generation of the user application Pod.

[STEP S102] Based on a container ID in the generated user application Pod, The internal application information acquisition unit 221a acquires the PID of the container thereof.

[STEP S103] The internal application information acquisition unit 221a acquires the inode number of a network namespace based on information of a file “/proc/[PID]” associated with the acquired PID.

[STEP S104] The internal application information acquisition unit 221a stores a Pod information resource including the Pod name, the IP address, and the inode number of the network namespace in a memory or a storage device.

Through the life and death monitoring of Pods described above, for example, when the user application Pod 210 is generated, the Pod information resource 41 associated with the user application Pod 210 is generated and managed by the internal application information acquisition unit 221a.

Next, the life and death monitoring processing of processes will be described in detail below. For example, the internal application information acquisition unit 221a performs the life and death monitoring of processes by periodically checking a “/proc” folder. When a new “/proc/[PID]” file is generated in the “/proc” folder, the internal application information acquisition unit 221a detects the generation of the new “/proc/[PID]” file. The internal application information acquisition unit 221a acquires the inode number for the network namespace by checking a “/proc/[PID]/ns” folder of the PID.

For example, multiple files that appear to be symbolic links are located in the “/proc/[PID]/ns” folder. Among these files, “/proc/[PID]/ns/net” is a file for operating a network namespace of a process associated with [PID]. The internal application information acquisition unit 221a refers to a target of the symbolic link of this file for operating the network namespace by using a readlink or “Is -I” command. In this way, it is possible to acquire the inode number of the network namespace used by the process.

For example, when the PID is “1”, the internal application information acquisition unit 221a instructs the OS 201 to execute a “readlink /proc/1/ns/net” command with a superuser right. The OS 201 returns, for example, information of “net: [4026531968]”. The digit string in the returned information is the inode number of the network namespace. When the PID is “1”, the internal application information acquisition unit 221a instructs the OS 201 to execute a “Is -Ia /proc/1/ns/net” command with a superuser right. The OS 201 returns, for example, information of “Irwxrwxrwx 1 root root 0 Jan 17 11:09 /proc/1/ns/net -> ‘net:[4026531968]”’. The digit string at the end in the returned information is the inode number of the network namespace.

After acquiring the inode number of the network namespace, the internal application information acquisition unit 221a searches for an associated Pod information resource. For example, the internal application information acquisition unit 221a searches the Pod information resources 41, 42, 43, ... in the Pod information resource group 40 by using the acquired inode number as a search key. The internal application information acquisition unit 221a determines that a user application Pod associated with the Pod information resource hit in the search is a user application Pod including the generated process. After identifying the user application Pod including the generated process, the internal application information acquisition unit 221a adds the PID of the generated process to the associated Pod information resource.

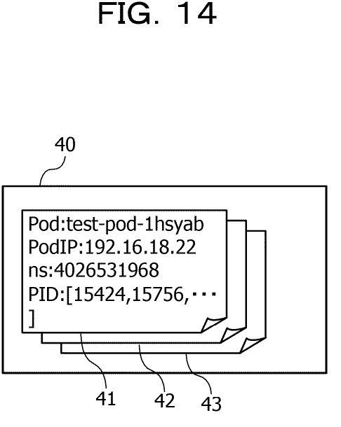

FIG. 14 is a diagram illustrating an example of a Pod information resource to which the PID of a generated process is added. The PID such as “15756” is added as the PID of the generated process to the Pod information resource 41. By adding the PID of each generated process to the Pod information resources 41, 42, 43, ... in this manner, the user application Pod is associated with the PIDs (PID list) of the multiple processes running in the user application Pod.

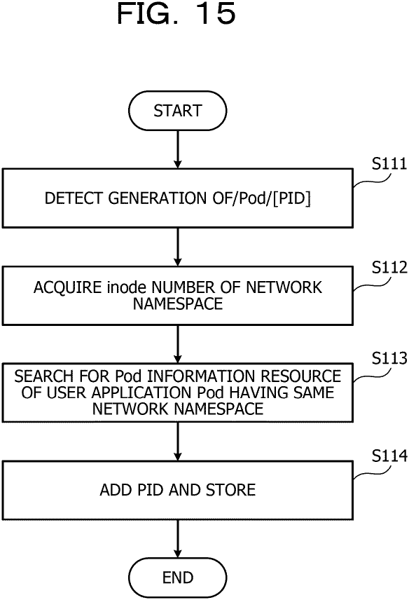

FIG. 15 is a flowchart illustrating an example of a processing procedure in response to process generation. Hereinafter, processing illustrated in FIG. 15 will be described in the order of step numbers.

[STEP S111] The internal application information acquisition unit 221a detects generation of a new “/Pod/[PID]” file in the “/proc” folder. The internal application information acquisition unit 221a recognizes a character string in a [PID] portion of the generated file as the PID of the generated process.

[STEP S112] The internal application information acquisition unit 221a acquires the inode number of the network namespace used by the generated process based on the information of the “/Pod/[PID]” file.

[STEP S113] The internal application information acquisition unit 221a searches the Pod information resource group 40 for a Pod information resource of a user application Pod using the same network namespace as that of the generated process. For example, the internal application information acquisition unit 221a searches the Pod information resource group 40 for a Pod information resource including the inode number acquired in step S112.

[STEP S114] The internal application information acquisition unit 221a adds the PID of the generated process to the Pod information resource hit in the search in step S113.

In this way, every time a process is generated, the PID of the process is added to a Pod information resource of a user application Pod including the process.

In the life and death monitoring, it is also possible to detect a disappearance of a process. When a process disappears, it is desirable to delete the written PID of the disappeared process from the associated Pod information resource. However, in a case where one “/Pod/[PID]” file disappears from the “/proc” folder, it is difficult to keep track of which network namespace was used by the process associated with the disappeared file after the disappearance of the file. For example, when a disappearance of a process is detected, the internal application information acquisition unit 221a checks all the Pod information resources 41, 42, 43, ... and finds the PID whose associated “/Pod/[PID]” file does not exist. As the number of user application Pods increases, the overhead of such processing increases. The deletion of the PID may affect the performance of the entire system in some cases. However, it is not recommended that the PID deletion processing be executed at the expense of system performance because the importance of the PID deletion processing is not high. Accordingly, the internal application information acquisition unit 221a may perform one of the following two types of processing in order to cope with a disappearance of a process.

A first type of processing is to quickly delete the PID of the disappeared process. For example, the internal application information acquisition unit 221a stores the associations between PIDs and network namespaces as a cache in a memory or a storage device. Thus, based on a PID, it is possible to quickly access the Pod information resource in which the PID is written. As a result, it is also possible to efficiently detect the PID of the disappeared process and suppress deterioration in the system performance.

A second type of processing is not to perform anything at the time of a disappearance of a process, but to, when detecting a PID whose process does not exist any more in the course of identifying a transmission source application of a query, delete the PID from the Pod information resource. For example, there is a case where another process assigned the same PID as that of the disappeared process is generated and the same PID as that of the generated process exists previously. In this case, the internal application information acquisition unit 221a detects that the same PID is registered in a Pod information resource including a network namespace different from that of the PID of the process associated with the transmission source of the query, and recognizes the presence of the PID of the disappeared process. When recognizing the presence of the PID of the disappeared process, the internal application information acquisition unit 221a deletes the PID.

A behavior closer to the ideal is the first type of processing. However, even when the second type of processing is adopted, the adverse effect is small. This is because a process that does not exist anymore does not output any query, and even if the PID of a process that does not exist anymore in the Pod remains in searching for a transmission source of a query, the search is just ended while the process with the PID is determined as irrelevant and is not detected. Even so, an excessive increase in the number of PIDs to be searched may cause a decrease in the processing speed. For this reason, it is preferable that as soon as a disappearance of a process is found, the PID of the concerned process be deleted from the Pod information resource.

Next, processing in response to output of a query will be described in detail below.

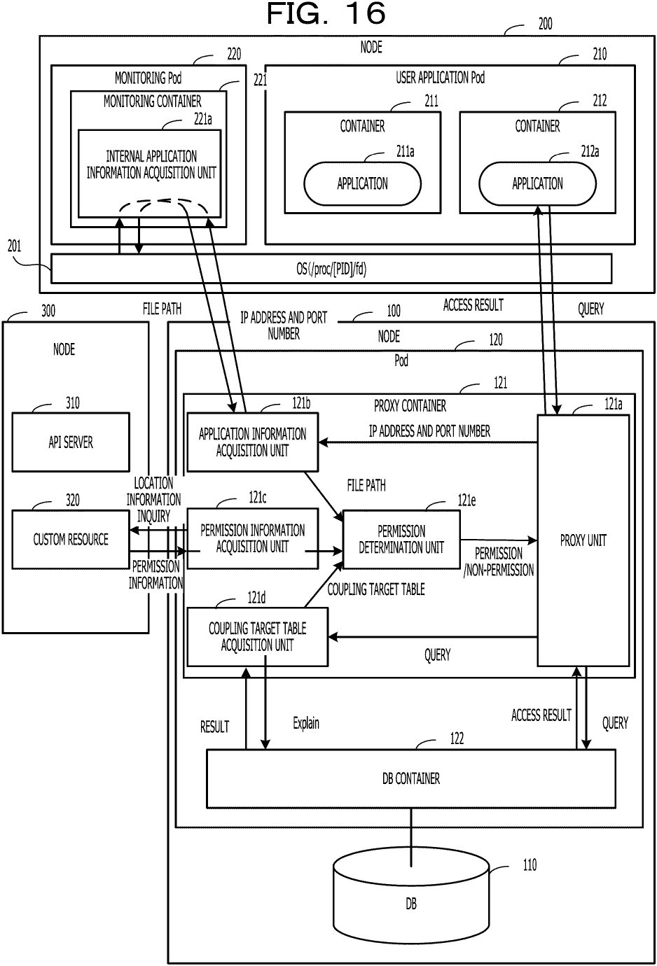

FIG. 16 is a diagram illustrating flows of information in DB access. For example, it is assumed that the application 212a in the container 212 outputs a query to refer to data in a table which the application 212a is permitted to access. The output query is transmitted to the proxy unit 121a in the proxy container 121. The proxy unit 121a transmits the IP address and the port number of the transmission source of the query to the application information acquisition unit 121b. The proxy unit 121a transmits the query to the coupling target table acquisition unit 121d.

The application information acquisition unit 121b transmits the set of the IP address and the port number of the transmission source of the query to the monitoring container 221. The internal application information acquisition unit 221a in the monitoring container 221 identifies the Pod information resource including the acquired IP address from the Pod information resources 41, 42, 43, ... in the Pod information resource group 40. The internal application information acquisition unit 221a acquires the inode number of the network namespace specified in the identified Pod information resource and the PID list of processes running in the network namespace. Next, the internal application information acquisition unit 221a accesses the network namespace specified by the inode number, and acquires the inode number associated with the port number of the transmission source (the inode number of the transmission source application).

The internal application information acquisition unit 221a searches the “/proc/[PID]/fd” folders for the PIDs specified in the PID list to find a file descriptor associated with the inode number of the transmission source application. The PID of the matched folder is the PID of the transmission source application. In this search, only the PIDs in the target Pod information resource may be used as the PIDs to be searched. For this reason, the execution time may be reduced as compared with the case where the PIDs of all the processes in the node 200 are set as the search targets.

After identifying the PID of the transmission source application, the internal application information acquisition unit 221a acquires the application name and the path from information such as “/proc/[PID]/exe” based on the PID of the transmission source application. The internal application information acquisition unit 221a transmits the file path (path + application name) of the transmission source application to the application information acquisition unit 121b in the node 100.

The application information acquisition unit 121b transmits the acquired file path to the permission determination unit 121e. The permission information acquisition unit 121c transmits an inquiry about the permission information to the custom resource 320. The custom resource 320 transmits the permission information to the permission information acquisition unit 121c. The permission information acquisition unit 121c transmits the acquired permission information to the permission determination unit 121e.

The coupling target table acquisition unit 121d transmits an Explain command in the query transmitted from the proxy unit 121a to the DB container 122. The DB container 122 transmits an Explain result including the coupling target table name of the query to the coupling target table acquisition unit 121d. The coupling target table acquisition unit 121d transmits information specifying the coupling target table to the permission determination unit 121e.

The permission determination unit 121e determines whether or not access of the query is permitted based on the file path, the permission information, and the coupling target table name, and transmits a determination result (permission or non-permission) to the proxy unit 121a. The proxy unit 121a transmits the query to the DB container 122. The DB container 122 accesses the DB 110 according to the query by the RDBMS, and transmits an access result to the proxy unit 121a. When it is determined that the access is permitted, the proxy unit 121a transmits the acquired access result to the application 212a.

According to the access control function as illustrated in FIG. 16, the proxy container 121 catches a query to the DB 110 in the middle, and identifies the application of the transmission source and the coupling target table based on the content (query) of the communication of the application of the transmission source. If the permission information that permits the identified application to access the coupling target table is set, a result of access to the DB 110 based on the query is transmitted to the application of the transmission source of the query.

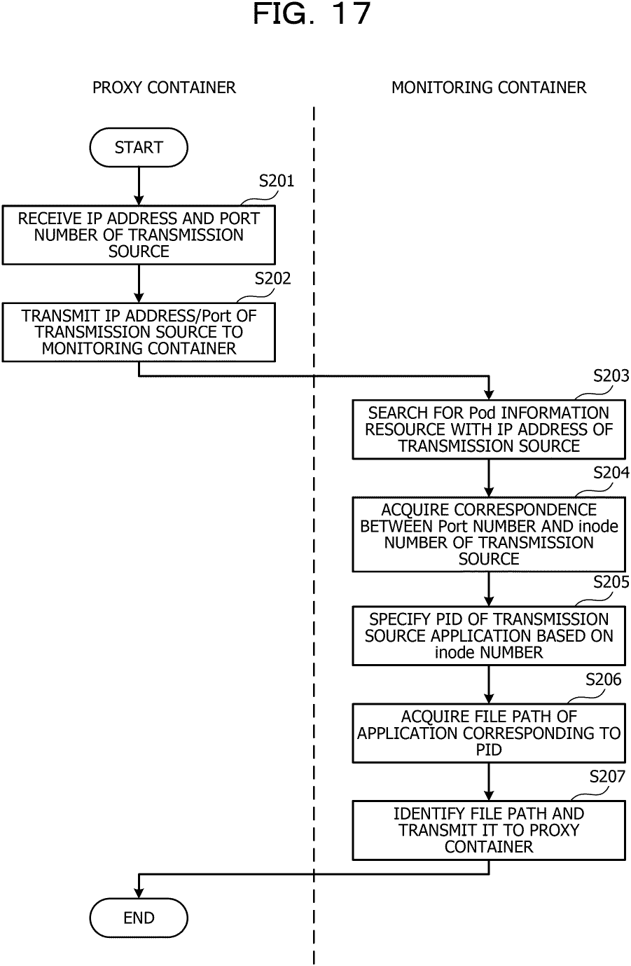

FIG. 17 is a flowchart illustrating an example of an application file path acquisition procedure. Hereinafter, processing illustrated in FIG. 17 will be described in the order of step numbers.

[STEP S201] In the proxy container 121, the application information acquisition unit 121b receives the IP address and the port number of a transmission source of a query from the proxy unit 121a.

[STEP S202] The application information acquisition unit 121b transmits the set of the IP address and the port number of the transmission source to the monitoring container 221.

[STEP S203] In the monitoring container 221, the internal application information acquisition unit 221a searches the Pod information resources in the Pod information resource group 40 by using the IP address of the transmission source. The internal application information acquisition unit 221a identifies the Pod information resource including the IP address of the transmission source as the Pod information resource of the user application Pod including the application of the transmission source.

[STEP S204] The internal application information acquisition unit 221a acquires an association relationship between the port number of the transmission source and the inode number based on the identified Pod information resource. For example, the internal application information acquisition unit 221a identifies a network namespace based on the inode number of the network namespace specified in the identified Pod information resource, and accesses the network namespace. From the network namespace, the internal application information acquisition unit 221a acquires the inode number of a file used only by the application associated with the port number of the transmission source.

[STEP S205] The internal application information acquisition unit 221a identifies the PID of the application of the transmission source based on the inode number associated with the transmission source port number. For example, the internal application information acquisition unit 221a refers to the file descriptors of files used by the processes associated with the respective PIDs included in the PID list in the Pod information resource identified in step S203. The internal application information acquisition unit 221a detects the file descriptor that matches the inode number acquired in step S204. The internal application information acquisition unit 221a identifies the PID of the process using the detected file descriptor as the PID of the application of the transmission source.

[STEP S206] The internal application information acquisition unit 221a acquires the file path of the application associated with the identified PID. For example, the internal application information acquisition unit 221a accesses a file “/proc/[PID]/exe” ([PID] is the PID identified in step S205) and acquires information in the file. This file is a symbolic link to an execution file associated with the PID, and includes the file path of the corresponding file.

[STEP S207] The internal application information acquisition unit 221a transmits the acquired file path to the proxy container 121.

In this way, the proxy container 121 is able to acquire the file path of the application associated with the port number. Thus, even when the port number varies every time a query is transmitted from an application, the proxy container 121 is able to correctly recognize the application of the transmission source of the query.

To perform per-application access control to each table, the proxy container 121 grasps an application of a transmission source of a query and acquires the name of a coupling target table to be coupled for access.

In order to extract correct information from a query in a message, the query is analyzed by using a parser. However, since queries have various dialects varying among DBs, the implementation of a parser supporting all the DBs in the proxy container 121 is difficult and has a possibility that extensibility may be hindered.

For this reason, the proxy container 121 acquires a table of an access target by using relatively easy-to-analyze information named an Explain command for a query. Because it is basically easy to attach an Explain statement to a query afterward, the query does not have to be analyzed. Many RDBMSs are capable of returning an Explain result in the form of half-structured data such as yaml or JavaScript (registered trademark) Object Notation (JSON), and use of an Explain command makes it possible to extract a coupling target table name easily.

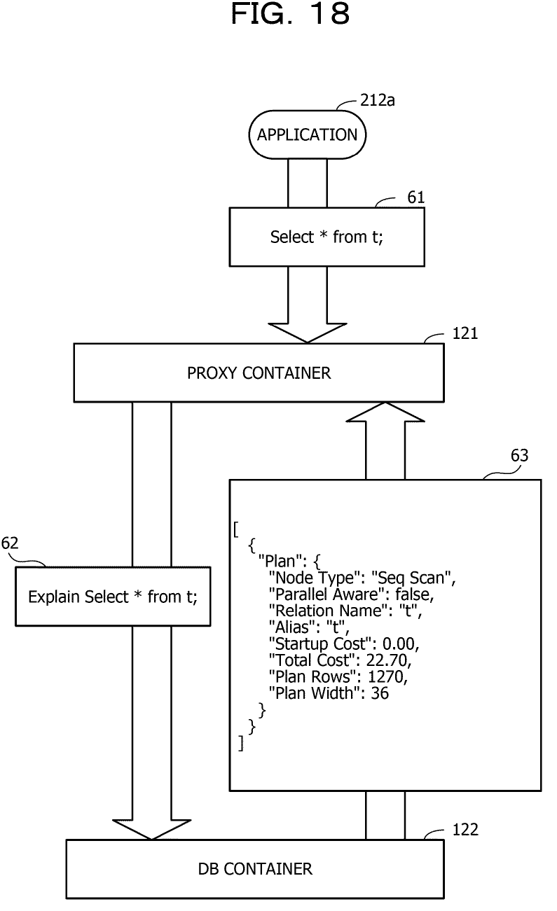

FIG. 18 is a diagram illustrating an example of a method of acquiring a coupling target table name. When a query 61 is transmitted from the application 212a to the proxy container 121, the coupling target table acquisition unit 121d in the proxy container 121 generates an Explain command 62 including the content of the query 61. The Explain command 62 is a command in which the content of the query 61 is described following a statement “Explain”. The coupling target table acquisition unit 121d transmits the generated Explain command 62 to the DB container 122.

When receiving the Explain command 62, the DB container 122 generates an execution plan for the query 61 specified in the Explain command 62. The DB container 122 transmits the execution plan as an Explain result 63 to the proxy container 121.

FIG. 18 illustrates an Explain result 63 in PostgreSQL. This Explain result 63 contains a name of a coupling target table ““Relation Name”: “t”,”. From the Explain result 63, the proxy container 121 extracts the description of the name of the coupling target table as the coupling target table name.

In this way, the proxy container 121 is able to generate the Explain command 62 only by adding the content of the query 61 to the character string of the Explain command. For example, while the analysis of a query itself inevitably involves interpretation of the character string, the use of the Explain command 62 makes it possible to acquire an execution plan in the JSON format as the Explain result 63. An execution plan in the JSON format may be analyzed by using an existing JSON library. Thus, the proxy container 121 reads the value of “Relation Name” in “Plan” in the Explain result 63 by using the JSON library. The read value is the name of the coupling target table. Thus, the use of the Explain command 62 makes it possible to easily determine the coupling target table.

Many DBs are equipped with a function of outputting an execution plan in response to the Explain command 62 and MongoDB in NoSQL, Neo4j in graph DB, and the like are not exceptions. For example, the determination of the coupling target table using the Explain command 62 is not limited to the RDBMS, but is similarly applicable to other various DBs.

The permission information specifying a type of application permitted to access a coupling target table is defined in advance in the custom resource 320 by the Pod creator 30. By acquiring the permission information from the custom resource 320, the proxy container 121 is able to recognize the application permitted to access the coupling target table.

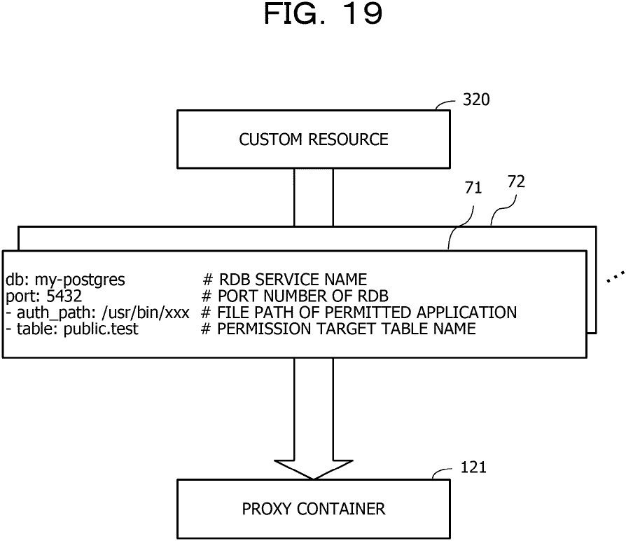

FIG. 19 is a diagram illustrating an example of the permission information acquired from the custom resource. For example, the proxy container 121 acquires pieces of permission information 71, 72, ... for all the data tables from the custom resource 320. One piece of the permission information 71, 72, ... is created for one RDB to which access restriction is applied. Each piece of the permission information 71, 72, ... includes a service name of the RDB, a port number of the RDB, a file path of an application to be permitted, a name of a permission target table, and the like.

The proxy container 121 compares a set of the file path of the application of the transmission source and the name of the coupling target table of the query 61 with the pieces of permission information 71, 72, ..., thereby determining whether or not the access is permitted.

The communication with the monitoring container 221 and execution of the Explain command 62 for acquiring the table may possibly be a nonnegligible overhead in the processing of accessing the DB 110. To address this, the proxy container 121 performs speculative execution of communication.

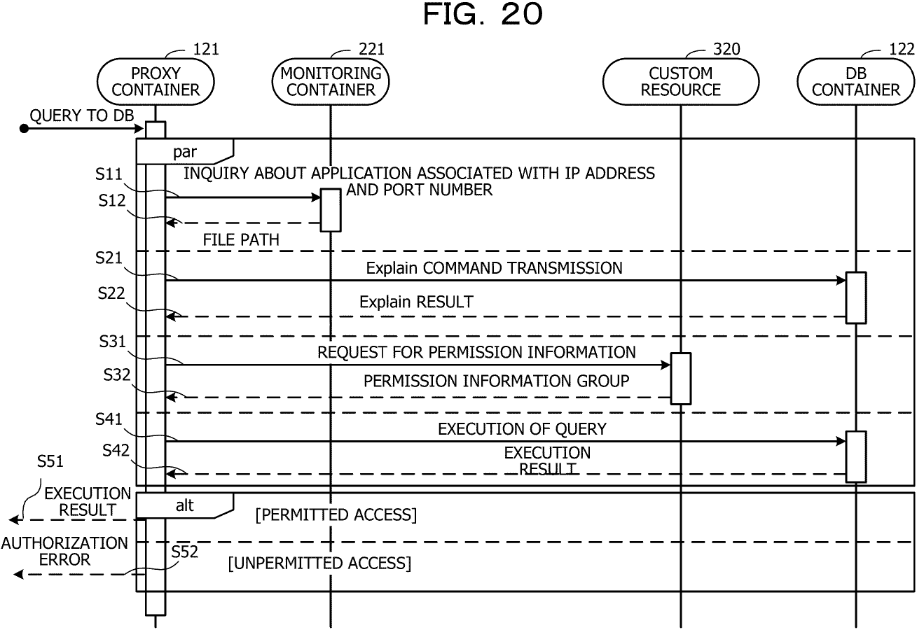

FIG. 20 is a sequence diagram illustrating an example of speculative DB access processing. When receiving a query for the DB 110, the proxy container 121 performs application file path acquisition processing, coupling target table name acquisition processing, permission information acquisition processing, and query execution processing on the DB 110 in parallel.

The application file path acquisition processing is divided into two steps S11 to S12. First, the proxy container 121 inquires of the monitoring container 221 an application associated with the set of the IP address and the port number of a transmission source of a query (step S11). The monitoring container 221 transmits the file path of the application to the proxy container 121 (step S12). The above is the application file path acquisition processing.

The coupling target table name acquisition processing is divided into two steps S21 to S22. First, the proxy container 121 transmits an Explain command including the content of the query to the DB container 122 (step S21). In response to the Explain command, the DB container 122 transmits an Explain result specifying a query execution plan (including the coupling target table name) to the proxy container 121 (step S22). The above is the coupling target table name acquisition processing.

The permission information acquisition processing is divided into two steps S31 to S32. First, the proxy container 121 requests permission information from the custom resource 320 (step S31). The custom resource 320 transmits a permission information group on all the data tables in the DB 110 to the proxy container 121 (step S32). The above is the permission information acquisition processing.

The query execution processing is divided into two steps S41 to S42. First, the proxy container 121 transmits a query to the DB container 122 to make a request to execute the query (step S41). The DB container 122 couples to the data table of the access target of the query, executes processing according to the query on the concerned data table, and transmits an execution result to the proxy container 121 (step S42). If the query requests to refer to data, the execution result includes data according to the query. If the query requests a data operation (such as update or deletion) in the DB 110, the execution result includes information specifying a success or failure of the operation processing. The above is the query execution processing.

The proxy container 121 determines whether or not access is permitted after completion of the application file path acquisition processing, the coupling target table name acquisition processing, and the permission information acquisition processing. When receiving the execution result of the query before determining whether or not the access is permitted, the proxy container 121 suspends a response to the application until the proxy container 121 is enabled to determine whether or not the access is permitted. When determining that the access to the coupling target table based on the query is permitted access, the proxy container 121 transmits the execution result of the query to the application of the transmission source of the query (step S51). On the other hand, when determining that the access to the coupling target table based on the query is unpermitted access, the proxy container 121 transmits a message indicating an authorization error to the application of the transmission source of the query (step S52).

An example illustrated in FIG. 20 is based on the assumption that execution of a query is completed within a short time. When it takes a long time to execute a query, a result of determining whether or not the access is permitted may be obtained before the completion of the execution of the query in some cases. In this case, if the access is unpermitted, the occurrence of unnecessary processing may be minimized by cancelling the execution of the query.

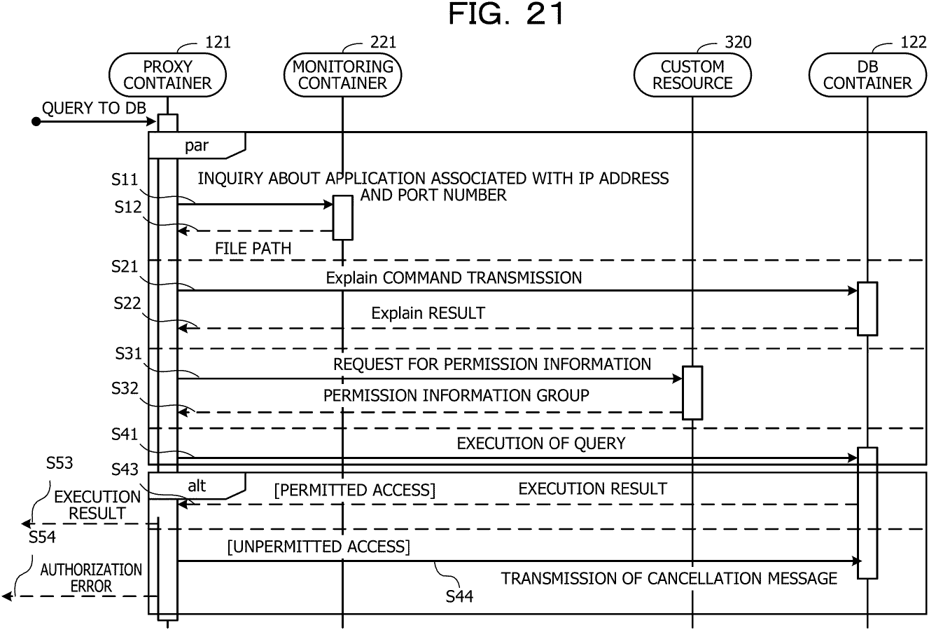

FIG. 21 is a sequence diagram illustrating an example of speculative DB access processing in a case where it takes time to execute a query. As in FIG. 20, the application file path acquisition processing, the coupling target table name acquisition processing, the permission information acquisition processing, and the query execution processing on the DB 110 are performed in parallel. Details of the application file path acquisition processing, the coupling target table name acquisition processing, and the permission information acquisition processing are also the same as in FIG. 20. The query execution processing up to a request to execute the query (step S41) is the same as in FIG. 20.

When determining that the access is permitted before the execution of the query is completed, the proxy container 121 waits for reception of an execution result from the DB container 122. After that, when the execution of the query is completed, the DB container 122 transmits the execution result of the query to the proxy container 121 (step S43). The proxy container 121 transmits the execution result of the query to the application of the transmission source of the query (step S53).

On the other hand, when determining that the access is unpermitted before the execution of the query is completed, the proxy container 121 transmits a message indicating cancellation of the execution of the query to the DB container 122 without waiting for the completion of the execution of the query (step S44). The proxy container 121 transmits a message indicating an authorization error to the application of the transmission source of the query (step S54).

The execution of the processing as described above makes it possible to achieve per-application access control while minimizing an overhead added to the original communication processing.

As described above, the system according to the second embodiment is able to optimize the components and reduce the overhead for the access control on the per-table basis dependent on each application in a container, and thus to achieve better performance. For example, in a node in which about 1600 processes operate, it takes about 0.2 to 0.25 seconds to perform all scanning. However, if it is possible to limit this search to only a few processes in a user application Pod, the search time in, for example, a user application Pod in which about 10 processes are running is within about 0.0015 seconds. As described above, the overhead may be significantly reduced.

### Other Embodiments

Although the permission information acquisition processing is performed every time a query is received in the second embodiment, the permission information may be held as a cache once the permission information is acquired. Accordingly, the permission information acquisition processing from the custom resource 320 may be omitted when a query to the same table is received from the same application thereafter.

Although the embodiments are exemplified hereinabove, the configurations of the units described in the embodiments may be replaced with others having similar functions. Arbitrary other component or step may be added. Arbitrary two or more configurations (features) of the embodiments described above may be combined.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An access control method causing a computer to execute a process comprising:
when detecting generation of a process in any of one or more containers, registering an association relationship between the generated process and an address for network communication in the container having the generated process in management information;
when detecting an output of an access request to a database, identifying a transmission source process using a transmission source port number of the access request from among one or more processes associated with a transmission source address of the access request in the management information;
identifying transmission source software executed by the identified transmission source process; and
determining whether an access to the database according to the access request from the identified transmission source software is permitted.

2. The access control method according to claim 1, wherein
the identifying the transmission source process includes acquiring file identification information of a file used in communication using the transmission source port number, and acquiring identification information of the transmission source process based on the acquired file identification information.

3. The access control method according to claim 2, wherein
the identifying the transmission source process includes searching one or more files respectively used by the one or more processes for a file associated with the acquired file identification information, and identifying the process using the searched-out file as the transmission source process.

4. The access control method according to claim 2, wherein
in the management information, information specifying a network namespace used in common by containers having a common address for network communication is set in association with the address, and
the registering the association relationship between the generated process and the address in the management information includes registering identification information of the generated process in association with the address associated with the network namespace used by the generated process.

5. The access control method according to claim 4, wherein
the identifying the transmission source process includes acquiring the file identification information of the file used in communication using the transmission source port number by accessing the network namespace associated with the transmission source address in the management information.

6. The access control method according to any one of claim 1, wherein
the determining whether the access to the database is permitted includes permitting the access to the database in a case where permission information in which software permitted to access each data table in the database is set includes a piece of information in which the transmission source software executed by the identified transmission source process is permitted to access a target data table to be accessed according to the access request.

7. A non-transitory computer-readable recording medium storing an access control program causing a computer to execute a process comprising:
when detecting generation of a process in any of one or more containers, registering an association relationship between the generated process and an address for network communication in the container having the generated process in management information;
when detecting an output of an access request to a database, identifying a transmission source process using a transmission source port number of the access request from among one or more processes associated with a transmission source address of the access request in the management information;
identifying transmission source software executed by the identified transmission source process; and
determining whether access to the database according to the access request from the identified transmission source software is permitted.

8. An information processing apparatus comprising:
a memory, and
a processor coupled to the memory and configured to:
register, when detecting generation of a process in any of one or more containers, an association relationship between the generated process and an address for network communication in the container having the generated process in management information;
identify, when detecting an output of an access request to a database, a transmission source process using a transmission source port number of the access request from among one or more processes associated with a transmission source address of the access request in the management information;
identify transmission source software executed by the identified transmission source process; and
determine whether access to the database according to the access request from the identified transmission source software is permitted.
